(19) United States
(12) Patent Application Publication
(10) Pub. No.: US 2004/0204160 A1
(43) Pub. Date: Oct. 14, 2004

(54) Hands-free communication device

(76) Inventors: Sadatoshi Zoraku, Tokyo (JP); Takashi Odagiri, Tokyo (JP)

Correspondence Address: MCDERMOTT WILL & EMERY LLP, 600 13TH STREET, N.W., WASHINGTON, DC, 20005-3096, US

(21) Appl. No.: 10/183,051

(22) Filed: Jun. 27, 2002

(51) Int. Cl. H04M 1/00

(52) U.S. Cl. 455/569.1; 455/575.2

(57) ABSTRACT

It is an object of the present invention to provide a communication device which is capable of being used for hands-free calls and which is easy to use. In order to achieve this object, the hands-free communication device of the present invention comprises an operating part including operation keys and a telephone receiver and microphone unit constructed in a manner freely attachable to and detachable from the operating part via an attachment. The telephone receiver and microphone unit comprises a microphone and a speaker, which are connected and integrated with each other via a connector. This configuration makes it possible to obtain the operability similar to that of a mobile cellular phone by mounting the telephone receiver and microphone unit on the operating part, and to realize the great convenience of being able to make hands-free calls by detaching the telephone receiver and microphone unit from the operating part.

### BACKGROUND OF THE INVENTION

1. Field of the Invention

The present invention relates to a mobile phone device capable of being used for hands-free calls.

2. Description of the Related Art

FIG. 3 is an external view of a conventional mobile phone device. As shown in FIG. 3, the conventional mobile phone device comprises operation keys 31 deployed on a body of a main phone device 30, a microphone 33 deployed near the lower end of the main phone device 30, and a speaker 32 deployed near the top end of the main phone device 30. With the phone device of this configuration, a caller can conduct radio telephone communications with a receiver by holding the body of the main phone device 30 with the speaker 32 into close contact with the caller's ear and by speaking into the microphone 33. However, in order to conduct radio telephone communications, the caller must always hold the main phone device 30, and, therefore, it is impossible to be hands-free when making a phone call.

FIG. 4 is an external view of a hands-free communication device. In order to realize the hands-free calls, a telephone receiver and microphone unit 27 and an operating part 20 of the device act as separate component units. The telephone receiver and microphone unit 27 is composed of a speaker 24 and a microphone 26, which are connected and integrated with each other via a connector 25. The operating part 20 comprises operation keys 21 and is connected to the telephone receiver and microphone unit 27 via a flexible cord 22. In order for a caller to make a phone call with the phone device of this configuration, the caller brings the speaker 24 into close contact with his/her ear by causing a semi-ring hook 23 rotatably pivoted on the both sides of the speaker 24 to engage with his/her ear, and places the microphone 26 near his/her mouth. Since the telephone receiver and microphone unit 27 is brought into close contact with the caller's ear and mouth while his/her hands are free, the caller can make a hands-free phone call without holding the telephone receiver and microphone unit.

However, in order to make hands-free calls, the caller must take the trouble to mount the telephone receiver and microphone unit 27 on his/her head, which is a drawback to the operability of the device. If the caller talks on such phone only for a short time or does not need to make a hands-free call because the caller's hands are free, a hands-free call may sometimes provide less convenience.

Accordingly, it is an object of the present invention to provide a phone device which is capable of being used for hands-free calls and which is easy to use.

### SUMMARY OF THE INVENTION

In order to achieve the aforementioned object, a hands-free communication device of the present invention comprises an operating part including operation keys, and a telephone receiver and microphone unit constructed in a manner freely-attachable to and detachable from the operating part and also constructed in a manner capable of being mounted on a caller's head while in the state of being detached from the operating part.

Since this configuration allows the telephone receiver and microphone unit to be attachable to and detachable from the operating part, if the telephone receiver and microphone unit is used in the state of being mounted on the operating part, it is possible to obtain the operability similar to that of a mobile phone. If the telephone receiver and microphone unit is detached from the operating part, it is possible to realize a hands-free call. Therefore, it is possible to provide a hands-free communication device with a great convenience.

Preferably, the telephone receiver and microphone unit includes a microphone and a speaker, which are connected and integrated with each other via a connector. By deploying an attachment in the operating part, which is detachable from the connector, it is possible to construct the operating part and telephone receiver and microphone unit so that they can be attached to and detached from each other.

Preferably, the speaker comprises a mounting tool for mounting an earphone on the caller's ear. According to this configuration, it is possible for the caller to easily mount the telephone receiver and microphone unit on his/her head by engaging a hook with his/her ear.

### BRIEF DESCRIPTION OF THE DRAWINGS

FIG. 1 is a perspective view of the front side of the hands-free communication device of the present invention.

FIG. 2 is a perspective view of the back side of the hands-free communication device of the present invention.

FIG. 3 is an external view of a conventional mobile cellular phone device.

FIG. 4 is a perspective view of the front side of a conventional hands-free communication device.

### DESCRIPTION OF THE PREFERRED EMBODIMENTS

The present embodiment is explained below with reference to each of the attached drawings.

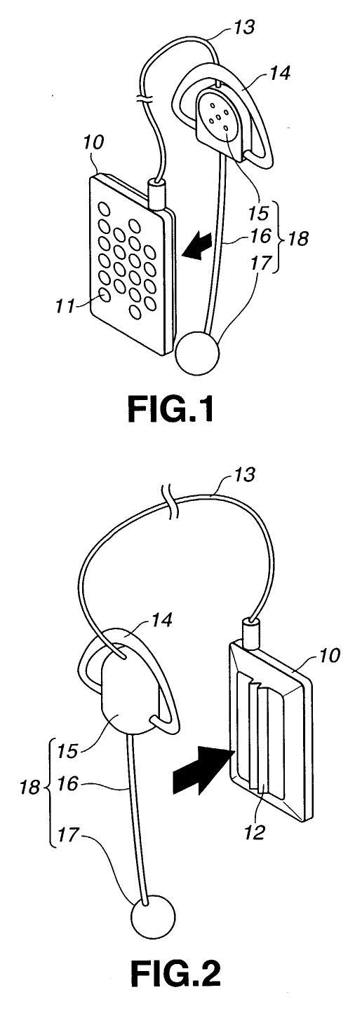

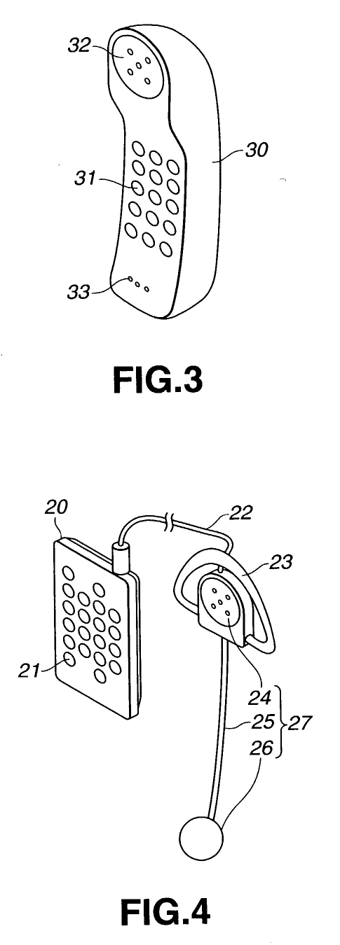

FIG. 1 is a perspective view of the front side of the hands-free communication device of the present invention, and FIG. 2 is a perspective view of the back side of the same device.

As shown in FIG. 1, the hands-free communication device of the present invention is constructed by including an operating part 10 and a telephone receiver and microphone unit 18 as main elements. The telephone receiver and microphone unit 18 consists of a speaker 15 and a microphone 17, which are connected via a connector 16. The connector 16 is a member which is gently curved according to the shape of the lateral surface of a caller's head, and the length of the connector 16 is long enough for the microphone 17 placed at the lower end of the connector 16 to be positioned near the caller's mouth when the speaker 15 positioned at the top end of the connector 16 is brought into close contact with the caller's ear. On both sides of the speaker 15, a semi-ring hook 14 which is a mounting tool for mounting an earphone is rotatably pivoted. The inside diameter of the semi-ring hook 14 is designed to be large enough to be engaged with the caller's ear. By engaging the hook 14 with his/her ear, the caller may mount the telephone receiver and microphone unit 18 on his/her head and conduct a hands-free call.

The operating part 10 comprises operation keys 11 for the caller to press and is used to input telephone numbers, etc. The operating part 10 includes various signal processing circuits which are necessary for radio telephone calls, and sends and receives voice signals to and from the telephone receiver and microphone unit 18 via a flexible cord 13. The connector 16 is made of a hollow thin cylinder, and is constructed in a manner such that the caller's voice signals inputted via the microphone 17 into the hollows are outputted via a lead wire into the signal processing circuits within the operating part 10. In this configuration, the voice signals inputted into the microphone 17 are sent via the cord 13 and processed as desired within the operating part 10 and are then sent to a receiver's telephone device via an antenna. After the caller's voice signals are received via the antenna, the voice signals are processed as desired and are then amplified and outputted from the speaker 15.

As shown in FIG. 2, in the longitudinal direction of the back side of the operating part 10 is formed an attachment 12 made of a plastic member having the inside diameter almost the same as the outside diameter of the connector 16, and this attachment 12 makes the telephone receiver and microphone unit 18 attachable to and detachable from the operating part 10. The hands-free communication device of the present invention in the state of having the telephone receiver and microphone unit 18 mounted on the attachment 12 can be used as an ordinary mobile cellular phone because the operating part 10 and telephone receiver and microphone unit 18 are integrated. On the other hand, the hands-free communication device of the present invention in the state of having the telephone receiver and microphone unit 18 detached from the attachment 12 enables hands-free calls because the operating part 10 and telephone receiver and microphone unit 18 are separated from each other.

As explained above, according to the present invention, since the telephone receiver and microphone unit 18 is constructed in a manner attachable to and detachable from the operating part 10, it is possible to utilize the device in different ways for intended purposes. For example, if both hands are occupied at the time of, for example, driving a car, it is possible to make a hands-free call by detaching the telephone receiver and microphone unit 18 from the attachment 12. On the other hand, if operability is required, for example, when the caller is in a crowd or needs to talk over the phone only for a short time, it is possible to obtain the operability and ease of use similar to that of a mobile phone by using the present invention in the state of having the telephone receiver and microphone unit 18 mounted on the attachment 12.

What is claimed is:

1. A hands-free communication device comprising:
(a) an operating part including operation keys; and
(b) a telephone receiver and microphone unit constructed in a manner freely attachable to and detachable from said operating part, and also constructed in a manner capable of being mounted on a caller's head while in the state of being detached from said operating part.

2. The hands-free communication device according to claim 1, wherein said telephone receiver and microphone unit includes a microphone and a speaker.

3. The hands-free communication device according to claim 2, wherein the microphone and the speaker are connected and integrated with each other via a connector.

4. The hands-free communication device according to claim 3, wherein said operating part comprises an attachment freely attachable to and detachable from the connector.

5. The hands-free communication device according to claim 4, wherein the speaker comprises a mounting tool for mounting an earphone on the caller's ear.

6. The hands-free communication device according to claim 5, wherein the operating part and the telephone receiver and microphone unit send and receive voice signals via a flexible cord.
